(19) United States
(12) Patent Application Publication
(10) Pub. No.: US 2021/0094121 A1
(43) Pub. Date: Apr. 1, 2021

(54) Methods, Systems, and Apparatuses for Laser Ablation Process Control in Real Time

(71) Applicant: The Boeing Company, Chicago, IL (US)

(72) Inventors: Benjamin W. Bolt, North Charleston, SC (US); Justin H. Register, Charleston, SC (US)

(21) Appl. No.: 16/721,188

(22) Filed: Dec. 19, 2019

Related U.S. Application Data
(60) Provisional application No. 62/907,785, filed on Sep. 30, 2019.

(51) Int. Cl. B23K 26/16; G01S 7/4912

(52) U.S. Cl. CPC B23K 26/16; G01S 17/88; G01S 7/4918

(57) ABSTRACT

Aspects of the present disclosure are directed to laser-based methods, systems, and apparatuses for monitoring and controlling in real time the precise amount of material removal from a composite substrate surface via laser-based material removal systems and controlling coating removal for livery rework using LIBS or Raman spectroscopy methodologies to monitor and control the material removal.

### TECHNOLOGICAL FIELD

The present disclosure relates generally to the field of removal of small amounts of material via laser ablation. More specifically the present disclosure relates to the field of using laser ablation for the removal of thin layers of coating materials and monitoring and controlling said removal.

### BACKGROUND

Aircraft and other vehicles and objects typically comprise surface ornamentation in the form of paint or coatings that are collectively referred to as liveries. When an object is reworked according to scheduled servicing, or when such liveries require reworking or alternate or newer coatings are to be applied to a substrate surface on such an object, processes are typically conducted to remove the original or prior coatings from the object's surface.

The substrate supporting the coatings will typically dictate the methods used to remove the outer coatings that are adhered to the substrate surface. The use of composite materials as substrate materials for objects including, for example, vehicles that can include, for example, aircraft, can impact the methods used to remove or “strip” coatings from the composite material substrate surface. Sanding machines manned by trained personnel have typically been used to remove aircraft liveries from composite material substrates. While automated process would be preferred, removal of thin coating layers mandates care, lest the underlying composite substrate sustain damage. As a result laborious hand sanding remains the typical livery-removing solution. Such processes are time-consuming, labor-intensive, and add significantly to the cost and time for reworking composite material coatings, including livery removal. In addition, the creation of removal debris in the form of dust that can be aspirated can contribute to environmental hazards that must be accounted for, further adding to processing cost and further contributing to processing time.

Various alternate solutions to sanding procedures have been attempted. However, such alternate approaches to coating removal from composite substrate surfaces has presented challenges. For example, while laser processes that can ablate thin layers from a substrate material seem promising, it has been difficult to assess the precise amount of material removal, and otherwise assess that the post laser-treatment condition of the substrate material that is desired has been achieved with certainty. That is, a coating and associated adhesive layers, if any, must be completely removed to assure the requisite degree of adhesion of subsequently applied, fresh coating layers that will form the basis of replacement or reworked coating for liveries.

### SUMMARY

Aspects of the present disclosure are directed to laser-based methods, systems, and apparatuses for, in real time, monitoring and controlling the precise amount of material removal from a composite substrate surface via laser-based material removal systems.

According to a present aspect, a method for removing a predetermined amount of material from a composite material substrate surface is disclosed, with the method including orienting a laser at a predetermined distance from a substrate material, with the substrate material including a substrate material surface, generating a laser beam from said laser, directing the laser beam to the substrate material surface, ablating a predetermined amount of a coating material from the substrate material surface, analyzing in substantially real time at least one of: the coating material ablated from the substrate material surface or an ablated substrate material surface. The disclosed method further includes generating a signal, sending a signal to a controller, with controller configured to be in communication with the laser, and controlling the ablation of coating material from the substrate material surface based on the signal sent to the laser from the controller.

According to a further aspect, controlling the ablation of the coating material from the substrate material includes terminating the laser beam and ceasing the ablation process based on the signal sent to the controller.

A further aspect includes generating a readout in substantially real time, said readout representing at least one of: the amount of material ablated from the substrate outer surface or the profile of the ablated substrate surface.

In another aspect, analyzing in substantially real time includes employing a laser induced breakdown spectroscopy methodology, system, or array.

In a further aspect, analyzing in substantially real time includes employing a Raman spectroscopy methodology, system, or array.

In another aspect, analyzing in substantially real time includes employing a fluorescence spectroscopy methodology, system, or array.

In another aspect, the method further includes spectrographically characterizing in substantially real time the surface profile of a laser-ablated substrate surface.

In a further aspect, the method further includes controlling in substantially real time the amount of material removed from the substrate material surface.

In another aspect, the method includes confirming in substantially real time the amount of material removed from the substrate material surface.

In another aspect, the method further includes controlling in substantially real time the laser ablation occurring to remove material from a substrate material surface.

According to a further present aspect, a system is disclosed including a laser configured to remove a predetermined amount of material from a substrate material surface, a controller in communication with the laser, said controller configured to control movement and orientation of the laser, a monitoring device in communication with at least one of the laser or the controller, said monitoring device configured to determine, and/or confirm, and/or control] a predetermined amount of material removed from the substrate material surface.

In another aspect, the substrate material surface includes a composite material.

In another aspect, the composite material is a fiber-containing epoxy-based composite material, with the fiber including at least one of: carbon fibers, boron fibers, glass fibers, aramid fibers, or combinations thereof

In another aspect, the material removed from the coating material surface includes at least one of a coating layer, a primer layer, an adhesive layer, a topcoat layer, a clearcoat layer, or combinations thereof

In another aspect, the monitoring device is configured to confirm in substantially real time the predetermined amount of material removed from the substrate surface.

In another aspect, the monitoring device is configured to characterize in substantially real time the surface profile of a laser-ablated substrate surface.

In a further aspect, the monitoring device is configured to control in substantially real time the amount of material removed from the substrate material surface.

In another aspect, the monitoring device is configured to control in substantially real time the laser ablation occurring to remove material from the substrate material surface.

In another aspect, the substrate material surface includes a composite material.

In another aspect, the substrate material surface includes a composite material.

In another aspect, the composite material is a fiber-containing epoxy-based composite material, with the fiber including at least one of: carbon fibers, boron fiber, glass fibers, aramid fiber, or combinations thereof.

In another aspect, the monitoring device includes a laser induced breakdown spectroscopy methodology.

In another aspect, the monitoring device includes a Raman spectroscopy methodology.

In a further aspect, the system further includes a memory, with the memory in communication with and/or accessible by the monitoring device.

In a further aspect, the memory includes at least one standard value, said standard value representing an ideal substrate surface profile.

In another aspect, the monitoring device is configured to assess the substrate surface in substantially real time during the removal of a predetermined amount of material from the substrate surface.

In a further aspect, monitoring device is configured to determine the presence or absence of atomic species at the substrate surface.

In another aspect, the coating material is doped with a predetermined atomic species, and wherein the monitoring device is configured to detect the presence or absence of the predetermined atomic species.

In another aspect, the substrate surface is doped with a predetermined atomic species, and wherein the monitoring device is configured to detect the presence or absence of the predetermined atomic species.

In a further aspect, the monitoring device comprises a fluorescent spectrometer, and wherein the predetermined atomic species fluoresces.

In a further aspect, the monitoring device comprises a fluorescent spectrometer, and wherein the predetermined atomic species fluoresces.

In another aspect, a method is disclosed including orienting a laser at a predetermined distance from a substrate material, with the substrate material including a substrate material surface, generating a laser beam from said laser, directing the laser beam to the substrate material surface, ablating a predetermined amount of a coating material from the substrate material surface, analyzing in substantially real time at least one of: the coating material ablated from the substrate material surface or an ablated substrate material surface. The disclosed method further includes generating a signal, sending a signal to a controller, with controller configured to be in communication with the laser, and controlling the ablation of coating material from the substrate material surface based on the signal sent to the laser from the controller. The method further discloses reworking a substrate surface.

In another aspect the method further includes a composite material reworked according to any of the aforementioned methods.

In another aspect, the composite material comprises a fiber-containing epoxy-based composite material.

In a further aspect, a component comprising the composite material is reworked according to any of the aforementioned methods.

In another aspect, the component includes a rework section.

In another aspect, a vehicle includes the component disclosed herein, with the vehicle selected from the group consisting of: a manned aircraft; an unmanned aircraft; a spacecraft; an unmanned spacecraft; a manned rotorcraft; an unmanned rotorcraft; a manned satellite, an unmanned satellite; a manned terrestrial vehicle; an unmanned terrestrial vehicle; a manned surface waterborne vehicle; an unmanned surface waterborne vehicle; a manned sub-surface waterborne vehicle; an unmanned sub-surface waterborne vehicle, a hovercraft, and combinations thereof.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

Having thus described variations of the disclosure in general terms, reference will now be made to the accompanying drawings, which are not necessarily drawn to scale, and wherein:

FIG. 1 is an illustration of a system according to a present aspect;

FIG. 2 is an illustration of a spectrograph showing insufficient ablation level, according to a present aspect;

FIG. 3 is an illustration of a spectrograph showing expected ablation level, according to a present aspect;

FIG. 4 is an illustration of a spectrograph showing excessive ablation, according to a present aspect;

FIG. 5 is a representative drawing of a vehicle in the form of an aircraft, according to a present aspect;

FIG. 6 is a flowchart outlining a method according to a present aspect;

FIG. 7 is a flowchart outlining a method according to a present aspect;

FIG. 8 is a flowchart outlining a method according to a present aspect; and

FIG. 9 is a flowchart outlining a method according to a present aspect.

### DETAILED DESCRIPTION

Aspects of the present disclosure are directed to the use of various methodologies for the purpose of discovering, monitoring, and controlling the proper amount of laser ablation occurring during removal of a coating from a composite substrate material surface. In the cases where the coating is a paint, primer, adhesive coating, topcoat, clearcoat, etc., the material removal can be a coating removal process otherwise referred to equivalently herein as a “depainting” process or a “livery rework” process or a “coating rework” process. Aspects of the present disclosure are directed to the use of laser-induced breakdown spectroscopy methodologies to determine that a predetermined level of surface treatment of a substrate surface has or has not been conducted. According to present aspects, an actual surface treatment value of a substrate material is determined using laser-induced breakdown spectroscopy (LIBS) methodologies, with the actual surface treatment profile value representing the level of surface treatment that a substrate surface has or has not sustained. The determined actual surface treatment profile value is then compared to an ideal substrate material surface profile value (referred to equivalently herein as an “ideal surface treatment value”, or “surface treatment standard”, or “standard value” or “reference value”) to determine whether or not the surface under examination has been treated to an adequate level, or degree, and will exhibit a predetermined surface characteristic (e.g., a surface roughness to facilitate coating adhesion, etc.) such that the substrate can undergo successful and predetermined further processing.

According to present aspects, the disclosed methods and systems confirm, with a high degree of accuracy, how a substrate material will perform during subsequent processing. According to further aspects, the determination of the level of treatment can be done quantitatively and in real time; and can further provide a map of an entire substrate, can provide information “in-line” during manufacture, and/or can “spot check” regions over a substrate surface in a post-manufacture inspection process. Preferably, the systems and methods disclosed herein are directed to the use of a LIBS methodology to accurate evaluate and otherwise determine the surface treatment levels of composite materials including carbon fiber epoxy-based composite materials and their surfaces.

Laser-induced breakdown spectroscopy (referred to equivalently herein as “LIBS”) is known as a type optical emission spectroscopy that incorporates an excitation source, such as a pulsed laser, that emits pulsed beams of energy. As the emitted energy beams from the laser are focused to a target area and impact the target area, a plasma proximate to the target surface atomizes and excites samples of the target surface. The formation of the plasma begins when the focused laser achieves a certain threshold for optical breakdown. This typically depends on the environment and the target substrate material. Since elements in their atomic form emit light of characteristic frequencies when excited to specified high temperatures, LIBS can detect present elements, limited, for example, by the power of the laser, the sensitivity or wavelength range of the spectrograph, the sensitivity or wavelength range of the detector, etc. LIBS detection limits are impacted by one of more of: a) the plasma excitation temperature, b) the light collection window, and c) the line strength of the viewed transition.

In LIBS methodologies, a laser beam is focused onto a small area at the surface of the specimen. When the laser beam impacts a target surface, the beam disrupts a very small amount of material from the target surface, with the disrupted amount of material typically in the range of nanograms to picograms. A plasma plume is then generated, with temperatures in excess of 100,000 K. During data collection, typically when localized thermodynamic equilibrium has been established, plasma temperatures typically range from 5,000-20,000 K. Within the plasma plume, the disrupted surface material dissociates (breaks down) into excited atomic species. As the plasma expands at high velocities and cools, the characteristic atomic emission lines of elements present in the target substrate surface can be observed by the LIBS system and according to LIBS methodologies. The delay between the emission of so-called continuum radiation and characteristic radiation occurs at a rate of about 10 microseconds.

While past work has focused on use of LIBS methodologies to detect impurities present on a target surface, according to present aspects, it has now been determined that LIBS methodology can be employed as a quantitative method for determining the adequate surface preparation or surface treatment of a target surface and, more specifically, for determining whether or not a composite material substrate has been surface treated at all and whether or not a composite material substrate has been surface treated sufficiently for a predetermined condition (for example, attaining a roughness, or other surface characteristic to promote a predetermined. amount of adhesion with subsequent coatings applied to the treated composite material substrate surface, etc.).

Raman spectroscopy is a spectroscopic technique used to determine vibrational modes of molecules. Raman spectroscopy is commonly used to provide a structural fingerprint by which the presence of various molecules can be identified. Raman spectroscopy is based on the inelastic scattering of photons, known as Raman scattering. A source of monochromatic light is used, that can be from a laser. The laser light interacts with molecular vibrations, photons or other excitations in the system, resulting in the energy of the laser photons being shifted up or down. The shift in energy provides information about the vibrational modes in the system.

Typically, a sample is illuminated with a laser beam. Electromagnetic radiation from the illuminated spot is collected with a lens and sent through a monochromator. Elastic scattered radiation at the wavelength corresponding to the laser line (Rayleigh scattering) is filtered out by either a filter such as a notch filter, an edge pass filter, or a band pass filter, with the rest of the collected light dispersed onto a detector.

The magnitude of the Raman effect correlates with polarizability of the electrons in a molecule. It is a form of inelastic light scattering, where a photon excites the sample. This excitation puts the molecule into an energy state for a short time before the photon is emitted. Inelastic scattering means that the energy of the emitted photon is of either lower or higher energy than the incident photon. After the scattering event, the sample is in a different rotational or vibrational state. For the total energy of the system to remain constant after the molecule moves to a new rotational-vibrational-electronic state, the scattered photon shifts to a different energy, and therefore a different frequency. This energy difference is equal to that between the initial and final rovibronic states of the molecule. If the final state is higher in energy than the initial state, the scattered photon will be shifted to a lower frequency (lower energy) so that the total energy remains the same. This shift in frequency is called a Stokes lift, or downshift. If the final state is lower in energy, the scattered photon will be shifted to a higher frequency, which is called an anti-Stokes shift, or upshift. For a molecule to exhibit a Raman effect, there must be a change in its electric dipole-electric dipole polarizability with respect to the vibrational coordinate corresponding to the rovibronic state. The intensity of the Raman scattering is proportional to this polarizability change. Therefore, the Raman spectrum (scattering intensity as a function of the frequency shifts) depends on the rovibronic states of the molecule.

Raman spectroscopy requires a light source such as a laser. The resolution of the spectrum relies on the bandwidth of the laser source used. Generally shorter wavelength lasers give stronger Raman scattering due to the increase in Raman scattering cross-sections, but issues with sample degradation or fluorescence may result. Continuous wave lasers are most common for normal Raman spectroscopy, but pulsed lasers may also be used.

Raman scattered light is typically collected and either dispersed by a spectrograph or used with an interferometer for detection by Fourier Transform (FT) methods. In many cases commercially available FT-IR spectrometers can be modified to become FT-Raman spectrometers. In most cases, modern Raman spectrometers use array detectors such as CCDs. Various types of CCDs exist which are optimized for different wavelength ranges. The spectral range depends on the size of the CCD and the focal length of spectrograph used.

Fluorescence spectroscopy analyzes fluorescence from a sample, and involves using a beam of light, that can be UV light, that excites the electrons in molecules of certain compounds and causes them to emit light, including visible light. Devices that measure fluorescence are called fluorometers. An emission map is measured by recording the emission spectra resulting from a range of excitation wavelengths and combining them together. This is a three dimensional surface data set: emission intensity as a function of excitation and emission wavelengths and can be depicted as a contour map.

According to present aspects, LIBS methodology and LIBS instrument arrays, Raman spectroscopy methodologies and Raman spectroscopy instrumentation arrays, or fluorescence spectroscopy methodologies and fluorescence spectroscopy and fluorescence spectroscopy arrays are used in conjunction with a laser configured to ablate a coating material from a composite material substrate. The associated spectroscopy methodologies are integrated into the overall methods, systems and apparatuses for the purpose of monitoring, detecting, and controlling the laser to achieve a predetermined level of ablation, in real time, that will remove a coating material layer from a composite material substrate without damaging the underlying composite material substrate. According to further aspects, the incorporation of spectroscopic arrays and methodologies will also control the laser movement and beam intensity such that a coating material layer is completely removed from a composite substrate material surface without damaging the composite substrate material surface.

In a further aspect, the real time assessments of the substrate material surface are evaluated by a spectrometer and converted to signals and signal values that can be compared with optimal values from a memory or library. When the systems determine that a coating material is still present, the system will allow the laser to continue ablating the surface and completing a depainting cycle, for example. When the incorporated spectrographic system evaluate the substrate material surface, in real time, and determines that the depainting is completed (for, example, by detecting that no further coating material exists on a substrate material surface, the LIBS, Raman or fluorescence systems that are in control of the laser movement and intensity will send the appropriate signal to the laser to terminate operation of the laser such that ablation of the substrate material surface will cease.

According to a present aspect, both LIBS methodologies and Raman methodologies can be used to identify the presence of certain atomic elemental species present in a coating layer. Accordingly, one present aspect contemplates doping a coating layer with an element that is uncommon to the underlying substrate material that can be a carbon fiber epoxy-based composite material substrate. As the oriented spectrometer received photonic spectral emissions (LIBS methodology) or vibratory responses specific to an element doped into the coating material, the LIBS or Raman arrays that include appropriate software and elemental spectral intensity and vibratory memory libraries for the doped element or compound, will recognize the continued presence of the doped element or compound and allow the ablating laser to continue operation that continues the depainting process and the continuing removal of a coating layer that comprises the dopant. As the process continues, when the spectrometer associated with the LIBS or Raman array ceases to receive photonic spectral intensities or vibratory intensities associated with the dopant, a signal is sent from the LIBS or Raman array processor to a controller in communication with the ablating laser for the purpose of suspending laser operation and ceasing ablation of the target substrate.

According to a present aspect, the laser used for the ablation and “depainting” processes can also provide the energy necessary to provide the photonic spectral intensity molecular excitation for either the LIBS methodology and array or the Raman spectroscopy methodology and array. If necessary, after the laser and the ablation function of the contemplated methods, system, and apparatuses has been deactivated, further confirmatory processes with a second energy source (e.g., a second laser, etc.) can then be activated for the purpose of confirming that a predetermined amount of coating material has been removed without incurring damage to the underlying composite material substrate surface.

According to a further aspect, if fluorescence spectroscopy is the methodology to be associated with the laser instrumentation, appropriate doping of the coating material can be accomplished to achieve a similar result to that described above, with an appropriate energy source provided (e.g., a UV laser, etc.) for the purpose of enabling the fluorescence spectroscopy methodology and array.

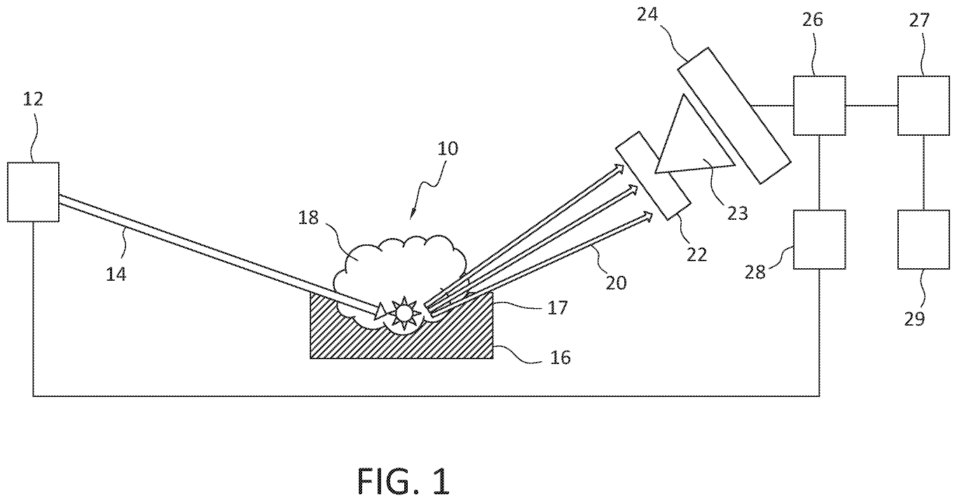

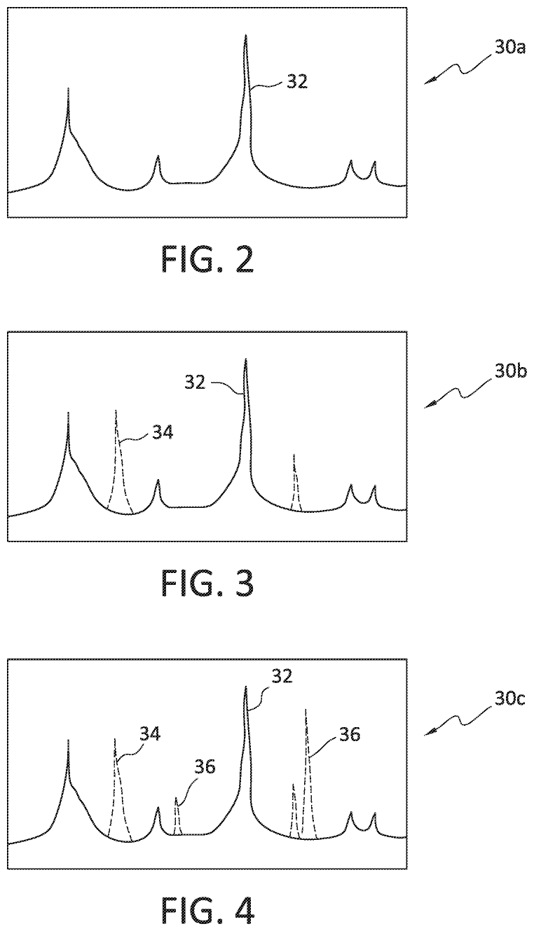

FIG. 1 is an illustration according to a present aspect and showing representative instrumentation. As shown in FIG. 1, a system 10 that can incorporate either a LIBS or Raman spectroscopy methodology includes a laser 12 that can be any laser capable of delivering energy at a wavelength that is compatible with the coating material layer 17 on substrate material 16 (that can be, for example, a composite material substrate, with the composite material comprising a carbon-containing composite material, etc.) for the purpose of achieving ablation of the coating material layer. In an operational mode as shown in FIG. 1, a laser beam 14 is emitted from laser 12 and directed to the coating material layer 17 located on the substrate material 16. As a plasma plume 18 at the surface is created during ablation and cools LIBS or Raman methodologies will receive scattered light 20 from the substrate surface as the coating material layer 17 is ablated. Spectrometer 22 receives the photonic spectral emissions in the scattered light as prism 23 directs the wavelengths of the scattered light 22 to detector 24. Data in the form of signals are sent from detector 24 to a processor 26 that is in communication with detector 24 and further in communication with controller 28. As the processor 26 runs applicable software pertaining to the LINS or Raman spectrometry array, the system 10 determines whether photonic spectral emission from identifiable molecules in the coating material are present in the plasma in the form of corresponding elemental or atomic peaks (See FIGS. 2, 3, and 4). As the ablation of the coating material proceeds, and as the available coating material still present on the substrate surface becomes depleted, the peaks recognized by the employed LIBS or Raman methodology will perceive the depletion of the photonic spectral intensities or vibratory characteristic present and send a termination signal to controller 28 that is further in communication with laser 12 for the purpose of ending the ablation of the target substrate surface.

FIGS. 2, 3, and 4 are representative and generalized spectra or elemental “fingerprints” 30a, 30b, 30c (e.g., non-specific to any particular elemental “fingerprint”, and presented for illustration purposes only) taken over the duration of a coating material ablation cycle or process. FIG. 2 shows a spectrograph 30a produced by or recognized by the present systems of an “underablation state”. As shown in FIG. 2, early in the ablation cycle the spectral fingerprint containing peak 32 can be representative of the fingerprint of the coating material being ablated, and therefore since only the coating material fingerprint has been perceived by the LIBS or Raman methodology/array associated with the ablation instrumentation, the system recognizes that ablation should continue until elements from the underlying substrate material appear in the spectrograph. The system at this point can be programmed (e.g., from an accessed memory or programmed specifically) to recognize that the particular spectrograph shown in FIG. 2, for example, relates to the presence of only the coating material being present in an ablative plume, or is otherwise the only material presently on the surface of the substrate. In other words, as shown in FIG. 2, since coating material is being recognized, the controller receives signals to that effect from the processor, and the controller allows the laser ablation of the substrate surface to continue so that the depainting processes proceed.

FIG. 3 shows a spectrograph 30b produced by or recognized by the present systems of “correct ablation state”. As shown in FIG. 3, as the spectral signature or fingerprint of the substrate material begins to emerge as spectral peaks 34 in the signature, the system recognizes, (e.g., from an accessed reference or standard of an optimized surface that has been adequately depainted) that an optimized state is approaching and system signals the controller that in turn shuts down the system curtailing any further ablation.

FIG. 4 shows a spectrograph 30c produced by or recognized by the present systems of “overablation state”. FIG. 4 shows a third spectral peak 36 emerging as a spectral peak series that represents damaged areas being formed in the composite material substrate. According to present aspects, the system can be shut down by the controller when the spectrograph shown in FIG. 3 is recognized by the system and an optimal (depainted) substrate surface has been achieved, and therefore the laser would be shut down prior to the system receiving spectral intensities evidencing damage to the substrate surface (e.g., “overablation” as shown in FIG. 4).

According to further alternate aspects, presently disclosed methods, systems, and apparatuses are employed for use as a quality control spot check tool, where inspections of, for example, depainted substrate material surfaces are conducted at some point in time after ablation has occurred. Such spot checks could then confirm optimal depainting (“correct ablation state”), as well as evidencing underablation (as shown in FIG. 2) or overablation (as shown in FIG.4). Such a “spot checking feature ” according to aspects of the present disclosure would not take advantage of features relating to the real time control of the system during ablation. In addition, such a “spot checking” feature could be useful when taking delivery of parts manufactured or processed from a third party, for example.

The term “substantially in real time” as used herein is understood to be a very short measure of time; e.g., virtually instantaneous. An instantaneous response is understood as being 100 microseconds. As the methods, systems, and apparatuses of the present disclosure measure, monitor and control the ablative processes in “real time”, the ablative surface conditions are sensed and commands are directed to the controller that, in turn, disengages or otherwise terminate the operation of the laser with a substantially real time period equaling a time period of ranging from about 100 microseconds or less (e.g., to about 10 picoseconds).

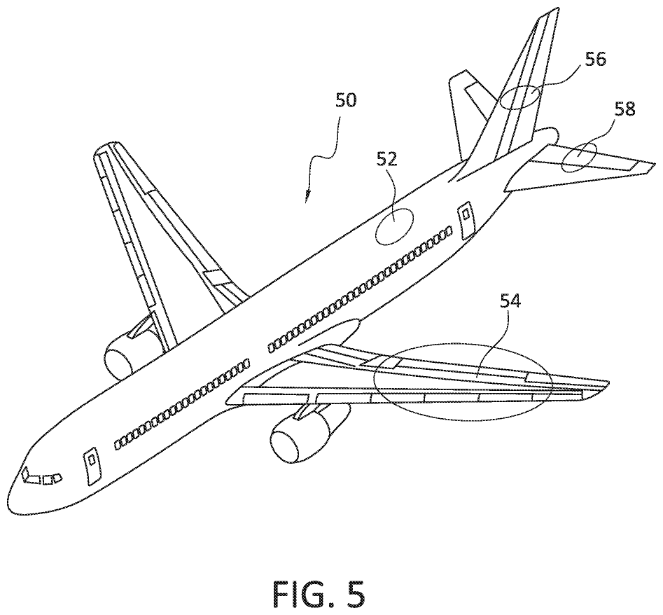

FIG. 5 is a representative illustration of a vehicle 50 (shown for non-limiting illustration purposes in the form of an aircraft). Present methods, systems and apparatuses are useful in the depainting of composite material used in the manufacture of components, such as those used in the manufacture of vehicles including a manned aircraft; an unmanned aircraft; a spacecraft; an unmanned spacecraft; a manned rotorcraft; an unmanned rotorcraft; a manned satellite, an unmanned satellite; a manned terrestrial vehicle; an unmanned terrestrial vehicle; a manned surface waterborne vehicle; an unmanned surface waterborne vehicle; a manned sub-surface waterborne vehicle; an unmanned sub-surface waterborne vehicle, a hovercraft, and combinations thereof.

As shown in FIG. 5, a vehicle 50 (shown for non-limiting illustration purposes in the form of an aircraft) can employ composite substrate material components used to depaint liveries from component surfaces such as those used in the manufacture of, and otherwise located, for example, in fuselage sections 52, wing sections 54, tail sections 56, stabilizer sections 58.

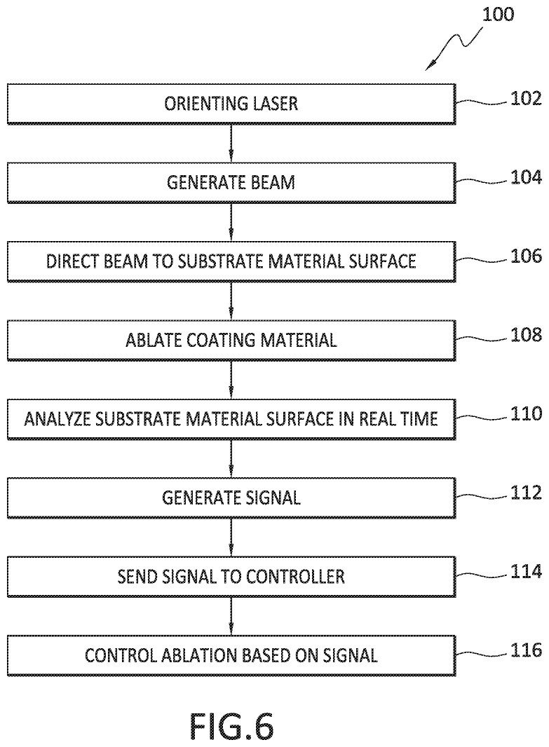

FIGS. 6, 7, 8, and 9 are flowcharts outlining presently disclosed methods. As shown in FIG. 6, a method 100 according to present methods includes, orienting 102 a laser at a predetermined distance from a substrate material, with the substrate material including a substrate material surface, generating 104 a laser beam from said laser, directing 106 the laser beam to the substrate material surface, ablating 108 a predetermined amount of a coating material from the substrate material surface, analyzing 110 in substantially real time at least one of: the coating material ablated from the substrate material surface or an ablated substrate material surface. The disclosed method further includes generating 112 a signal, sending 114 a signal to a controller, with controller configured to be in communication with the laser, and controlling 116 the ablation of coating material from the substrate material surface based on the signal sent to the laser from the controller.

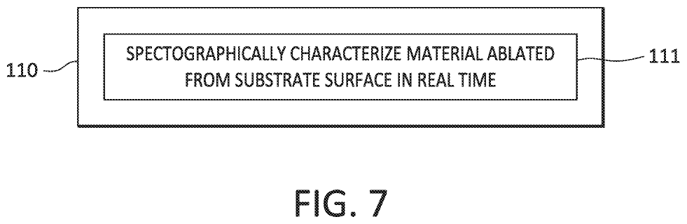

As shown in FIG. 7, the step of analyzing 110 in substantially real time at least one of: the coating material ablated from the substrate material surface or an ablated substrate material surface can further include spectrographically characterizing 111 material ablated from the substrate surface in real time, or spectrographically characterizing the substrate surface from which ablated material has been released.

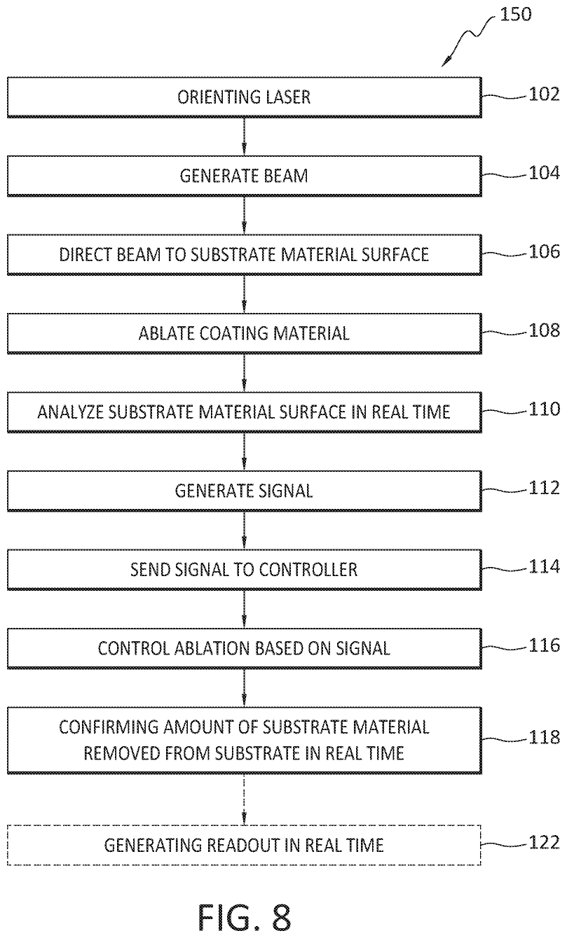

As shown in FIG. 8 a method 150 according to present methods includes, orienting 102 a laser at a predetermined distance from a substrate material, with the substrate material including a substrate material surface, generating 104 a laser beam from said laser, directing 106 the laser beam to the substrate material surface, ablating 108 a predetermined amount of a coating material from the substrate material surface, analyzing 110 in substantially real time at least one of: the coating material ablated from the substrate material surface or an ablated substrate material surface. The disclosed method further includes generating 112 a signal, sending 114 a signal to a controller, with controller configured to be in communication with the laser, and controlling 116 the ablation of coating material from the substrate material surface based on the signal sent to the laser from the controller. The method further includes confirming 118 an amount and type of material removed from a substrate material that can be, e.g., a coating material). Optionally, method 150 further comprises generating 122 a readout in substantially real time. The readout can be visible to an operator, and the readout can be incorporated into another of the present system components including, for example, at least one of: the controller, the processor, etc., or the readout can be present in the system as a separate readout device.

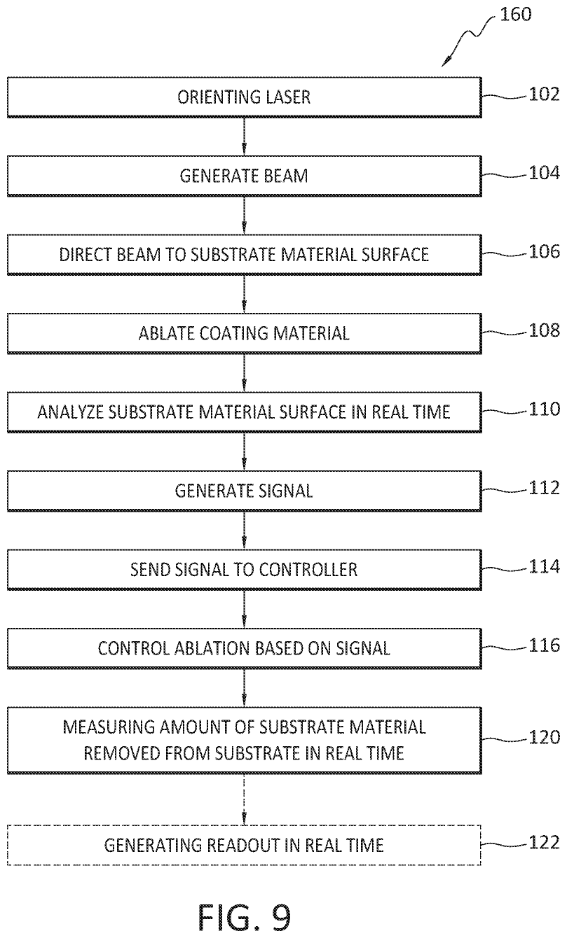

As shown in FIG. 9 a method 160 according to present methods includes, orienting 102 a laser at a predetermined distance from a substrate material, with the substrate material including a substrate material surface, generating 104 a laser beam from said laser, directing 106 the laser beam to the substrate material surface, ablating 108 a predetermined amount of a coating material from the substrate material surface, analyzing 110 in substantially real time at least one of: the coating material ablated from the substrate material surface or an ablated substrate material surface. The disclosed method further includes generating 112 a signal, sending 114 a signal to a controller, with controller configured to be in communication with the laser, and controlling 116 the ablation of coating material from the substrate material surface based on the signal sent to the laser from the controller. The method further includes measuring a predetermined amount of material (that can be e.g., a coating material) from a substrate material. Method 160 further includes measuring 120 the amount of substrate material removed from the substrate (e.g., through analyzing the plasma plume as described herein). Optionally, method 150 further comprises generating 122 a readout in substantially real time. The readout can be visible to an operator, and the readout can be incorporated into another of the present system components including, for example, at least one of: the controller, the processor, etc., or the readout can be present in the system as a separate readout device.

The present aspects may, of course, be carried out in other ways than those specifically set forth herein without departing from essential characteristics of the disclosure. The present aspects are to be considered in all respects as illustrative and not restrictive, and all changes coming within the meaning and equivalency range of the appended claims are intended to be embraced therein.

1. A method comprising:
orienting a laser at a predetermined distance from a substrate material, said substrate material comprising a substrate material surface and further comprising a coating material layer, said coating material layer oriented proximate to the substrate material surface, said coating material layer comprising an amount of coating material;
generating a laser beam from said laser;
directing the laser beam to the substrate material surface;
ablating a predetermined amount of the coating material from the substrate material surface;
analyzing in substantially real time at least one of: a predetermined amount of coating material ablated from the substrate material surface or an ablated substrate material surface profile;
generating a signal;
sending a signal to a controller, said controller configured to be in communication with the laser; and
controlling ablation of the coating material from the substrate material surface based on the signal sent to the laser from the controller.

2. The method of claim 1, further comprising:
generating a readout in real time, said readout representing at least one of: the amount of coating material ablated from the substrate outer surface or the ablated substrate material surface profile.

3. The method of claim 1, wherein the laser comprises a laser induced breakdown methodology.

4. The method of claim 1, wherein the laser comprises a Raman laser methodology.

5. The method of claim 1, wherein, in the step of analyzing in real time the coating material ablated from the substrate material surface, further comprising:
spectrographically characterizing in real time material ablated from the substrate material surface.

6. The method of claim 1, further comprising:
controlling in real time the amount of coating material removed from the substrate material surface.

7. The method of claim 1, further comprising:
confirming in real time the amount of coating material removed from the substrate material surface.

8. The method of claim 1, further comprising:
measuring in real time the amount of coating material removed from the substrate material surface.

9. A method for reworking a substrate surface, the method comprising:
orienting a laser at a predetermined distance from a substrate material, said substrate material further comprising a substrate material surface, said substrate material surface comprising a coating material;
generating a laser beam from said laser;
directing the laser beam to the substrate material surface;
ablating a predetermined amount of coating material from the substrate material surface;
analyzing in substantially real time at least one of: the coating material ablated from the substrate material surface or an ablated substrate material surface;
generating a signal;
sending a signal to a controller, said controller configured to be in communication with the laser; and
controlling the ablation of coating material from the substrate material surface based on the signal sent to the laser from the controller to form a reworked composite substrate material.

10. A substrate material reworked according to the method of claim 9.

11. The substrate material of claim 10, wherein the substrate material comprises a composite material, said composite material comprising a fiber-containing epoxy-based composite material.

12. The composite material of claim 11, wherein the composite material is a fiber-containing epoxy-based composite material comprising at least one of: carbon fibers, glass fibers, boron fibers, aramid fibers, and combinations thereof

13. A component comprising the composite material of claim 11.

14. A vehicle comprising the component of claim 13.

15. The vehicle of claim 14, wherein the vehicle is selected from the group consisting of: a manned aircraft; an unmanned aircraft; a spacecraft; an unmanned spacecraft; a manned rotorcraft; an unmanned rotorcraft; a manned satellite, an unmanned satellite; a manned terrestrial vehicle; an unmanned terrestrial vehicle; a manned surface waterborne vehicle; an unmanned surface waterborne vehicle; a manned sub-surface waterborne vehicle; an unmanned sub-surface waterborne vehicle, a hovercraft, and combinations thereof.

16. A system comprising:
a laser configured to remove a predetermined amount of material from a substrate material, said substrate material comprising a substrate material surface;
a controller in communication with the laser, said controller configured to control movement of the laser, said controller further configured to control orientation of the laser;
a monitoring device in communication with at least one of: a processor, the laser, or the controller, said monitoring device configured to determine a predetermined amount of material removed from the substrate material surface.

17. The system of claim 16, wherein the monitoring device is configured to confirm in substantially real time the predetermined amount of material removed from the substrate material surface.

18. The system of claim 16, wherein the monitoring device is configured to send signals to the controller to control in substantially real time the predetermined amount of material removed from the substrate material surface.

19. The system of claim 16, wherein the laser is configured to ablate a predetermined amount of material from the substrate material surface.

20. The system of claim 16, wherein the substrate material comprises a composite material.

21. The system of claim 16, wherein the substrate material comprises a carbon-containing composite material.

22. The system of claim 16, wherein the substrate material comprises a carbon fiber epoxy-based composite material.

23. The system of claim 16, wherein the substrate material surface comprises a coating material layer.

24. The system of claim 16, wherein the coating material layer comprises a coating, said coating comprising at least one of: a paint, a primer, an adhesive, a topcoat, a clearcoat, or combinations thereof.

25. The system of claim 16, wherein the monitoring device comprises a laser induced breakdown spectroscopy methodology.

26. The system of claim 16, wherein the monitoring device comprises a Raman spectroscopy methodology.

27. The system of claim 16, further comprising a memory, said memory in communication with the monitoring device.

28. The system of claim 16, wherein the monitoring device is configured to assess the substrate material surface in substantially real time during the removal of the predetermined amount of material from the substrate material surface.

29. The system of claim 16, wherein the monitoring device is configured to determine the presence or absence of a predetermined atomic species from the substrate material surface.

30. The system of claim 16, wherein the coating is doped with a predetermined atomic species, and wherein the monitoring device is configured to detect the presence or absence of the predetermined atomic species.

31. The system of claim 16, wherein the substrate material surface is doped with a predetermined atomic species, and wherein the monitoring device is configured to detect the presence or absence of the predetermined atomic species.

32. The system of claim 27, wherein the memory comprises an ideal substrate material surface profile value.

33. The system of claim 30, wherein the monitoring device comprises a fluorescent spectrometer, and wherein the predetermined atomic species fluoresces.

34. The system of claim 31, wherein the monitoring device comprises a fluorescent spectrometer, and wherein the predetermined atomic species fluoresces.
